(19) United States
(12) Patent Application Publication
(10) Pub. No.: US 2026/0044314 A1
(43) Pub. Date: Feb. 12, 2026

(54) DISTRIBUTED CODE GENERATION AND EXECUTION

(71) Applicant: NEC Laboratories America, Inc., Princeton, NJ (US)

(72) Inventors: Kunal Rao, Monroe, NJ (US); Giuseppe Coviello, Robbinsville, NJ (US); Srimat Chakradhar, Manalapan, NJ (US)

(21) Appl. No.: 19/291,875

(22) Filed: Aug. 6, 2025

Related U.S. Application Data
(60) Provisional application No. 63/680,703, filed on Aug. 8, 2024.

(51) Int. Cl. G06F 8/33

(52) U.S. Cl. CPC G06F 8/33

(57) ABSTRACT

Systems and methods for generating and executing distributed code. The systems and methods include analyzing code dependencies in a serial code with a trained model to evaluate opportunities to implement tasks in parallel and marking the serial code with indicators to designate portions of the serial code that can be performed on a plurality of computing devices. The methods and systems further include distributing the portions of the serial code to the plurality of computing devices and executing the serial code in parallel across the plurality of computing devices using an execution engine to coordinate execution across the computing devices.

### RELATED APPLICATION INFORMATION

This application claims priority to U.S. Provisional Patent Application No. 63/680,703, filed on Aug. 8, 2024, incorporated herein by reference in its entirety.

### BACKGROUND

### Technical Field

The present invention relates to generative artificial intelligence and more particularly generating computer code for execution on a distributed infrastructure.

### Description of the Related Art

A large portion of the cost relating to software development is directed towards hiring experts to develop high-quality software and then yet another group of experts to ensure that the software runs efficiently, typically, this is on a distributed infrastructure for modern, complex software with tight integration and interaction with several components.

Large Language Models (LLMs) have the potential to generate software. Consequently, attention has moved towards using LLMs in building complex software to alleviate and subsume some of the costs involved in software development and deployment.

Current implementations of LLM code generation only focus on serial code generation, however. This means the code can only be executed on a single computing device which limits the applicability of LLM code generation because many code bases are implemented in a distributed network. To this end, it is noted these solutions only focus on obtaining correct working code. This is the beginning of solving complex problems, but once there is correct, working code, the preference is for the code to run fast and efficiently.

### SUMMARY

According to an aspect of the present invention, a method is provided for generating and executing distributed code. The method includes analyzing code dependencies in a serial code with a trained model to evaluate opportunities to implement tasks in parallel and marking the serial code with indicators to designate portions of the serial code that can be performed on a plurality of computing devices. The method further includes distributing the portions of the serial code to the plurality of computing devices and executing the serial code in parallel across the plurality of computing devices using an execution engine to coordinate execution across the computing devices.

According to another aspect of the present invention, a system is provided for generating and executing distributed code. The system includes a processor and a memory storing computer-readable instructions. The memory causes the processor to analyze code dependencies in a serial code with a trained model to evaluate opportunities to implement tasks in parallel and mark the serial code with indicators to designate portions of the serial code that can be performed on a plurality of computing devices. The memory further causes the processor to distribute the portions of the serial code to the plurality of computing devices and execute the serial code in parallel across the plurality of computing devices using an execution engine to coordinate execution across the computing devices.

According to yet another aspect of the present invention, a computer program product is provided for generating and executing distributed code. The computer program product includes computer program code that when executed by one or more processors causes one or more processors to perform operations. The computer program product includes instructions to analyze code dependencies in a serial code with a trained model to evaluate opportunities to implement tasks in parallel and mark the serial code with indicators to designate portions of the serial code that can be performed on a plurality of computing devices. The computer program product further includes instructions to distribute the portions of the serial code to the plurality of computing devices and execute the serial code in parallel across the plurality of computing devices using an execution engine to coordinate execution across the computing devices.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for code generation and execution, in accordance with an embodiment of the present invention;

FIG. 2 is a block diagram illustrating a system for training a Large Language Model (LLM) code generator, in accordance with an embodiment of the present invention;

FIG. 3 is a block diagram illustrating a system for refining a system prompt for LLM code generation, in accordance with an embodiment of the present invention;

FIG. 4 is a block diagram illustrating a system for generating distributed code, in accordance with an embodiment of the present invention;

FIG. 5 is a block diagram illustrating execution of distributed code, in accordance with an embodiment of the present invention;

FIG. 6 is a flow diagram illustrating a method for performing distributed code generation, in accordance with an embodiment of the present invention;

FIG. 7 is a block diagram illustrating a system for forming a system prompt in greater detail, in accordance with an embodiment of the present invention;

FIG. 8 is block diagram illustrating a system for generating and executing distributed code, in accordance with an embodiment of the present invention; and

FIG. 9 is a block diagram illustrating an artificial neural network for employing LLMs, in accordance with an embodiment of the present invention.

### DETAILED DESCRIPTION OF PREFERRED EMBODIMENTS

Embodiments of the present invention can include a large language model (LLM) based tool which automatically generates a distributed version of code and a component that understands the program semantics and executes independent tasks within the program on a cluster of computing devices. Other solutions to optimize LLM generated code have attempted to generate parallel code but focus on low-level parallelization such as optimizing for multiple cores or unique characteristics of the central processing units (CPU) or graphics processing unit (GPU) architecture. Embodiments of the present invention take advantage of multiple computing devices, each having GPUs to distribute execution of code. Though use of multiple computing devices is not necessary.

In an embodiment of the present invention, the computing devices can be clusters, computers, edge devices, internet of things (IoT) devices, servers, setups, machines, etc. Each computing device can be a GPU, CPU, tensor processing unit (TPU), neural processing unit (NPU), other application specific integrated circuit (ASIC), field programmable gate array (FPGA), etc., or any combination thereof. The specific hardware that the computing device is housed on can be located at a single location or at several locations or a combination thereof.

In embodiments of the present invention, the LLM-based tool analyzes dependencies in the serial code and at a high-level evaluates whether there are opportunities to implement the same tasks in parallel. Once these opportunities are discovered, the code is marked with semantics so that the code can be performed on several computing devices. In other words, the program can have one set of processes performed on a different device than other processes and the devices know which portion to execute based on indications in the code.

For example, an Application Programming Interface (API) and other finer granularity/low-level compiler optimization techniques, e.g., vectorization, loop unrolling, instruction level parallelism, etc., can be used to improve computational efficiency. The processes can be performed on separate pieces of hardware (e.g., devices). Each API call is considered as a task, and the LLM-based tool transforms the code such that independent tasks can be distributed and run in parallel, as opposed to sequentially, which is what occurs when serial code is performed (and the code must be performed on a single piece of hardware).

The distributed version of the code generated by the LLM-based tool follows specific program semantics, which can be understood by an underlying runtime. Once the distributed code is generated by the LLM-based tool, the runtime component understands the program semantics and efficiently executes independent tasks within the program on a distributed computing devices in the proper order.

In an embodiment of the present invention, an artificial intelligence (AI) model being trained or executed on a cluster of computing devices can apply parallel tasks well and is suitable for using distributed code. AI models often compute the same type of calculation many times and can utilize GPUs because GPUs are designed to process the same task many times and can be stored on several different computing devices. This may be more efficient than performing the same task on a single computing device which may use a CPU instead, which is less efficient at performing the same task repetitively.

AI models can perform any number of tasks such as image classification, object detection, segmentation, pose estimation, speech recognition, speaker identification, sound event detection, named entity recognition, sentiment analysis, semantic similarity, text generation, code generation, machine translation, summarization, image synthesis, video generation, text to speech, music generation, game-playing, robotics control, route optimization, multi-agent coordination, symbolic reasoning, theorem proving, multi-hop question answering (QA), commonsense reasoning, recommender systems, dialogue agents, personal assistants, adaptive learning systems, anomaly detection, time series forecasting, clustering/classification/regression, feature selection and dimensionality reduction, etc. This is not intended to be limiting, and this list is non-exclusive.

In some embodiments of the present invention, code generation can be associated with Synthia and code execution can be associated with Hermod.

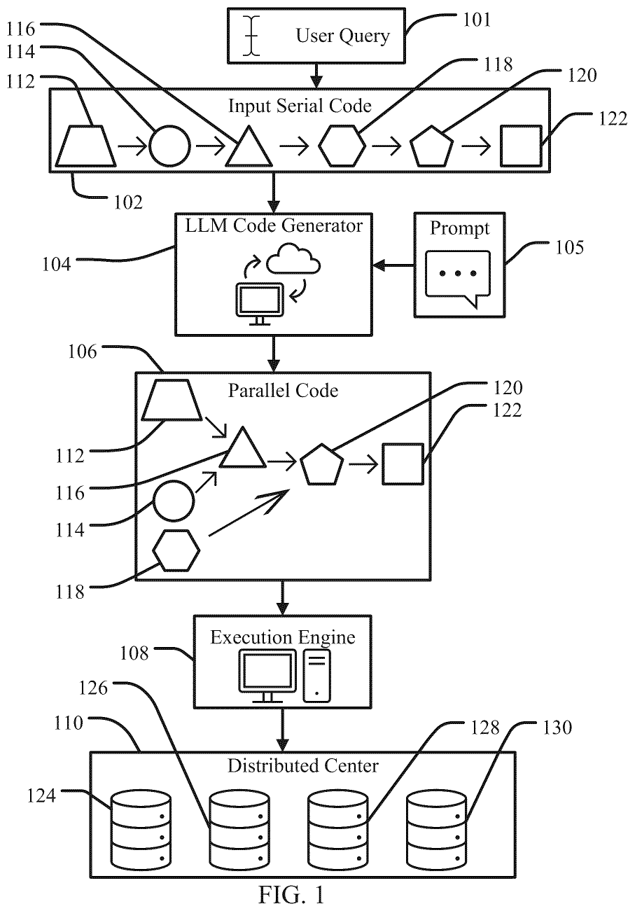

Referring now in detail to the figures in which like numerals represent the same or similar elements, and initially to FIG. 1, a high-level architecture of the code generation framework is illustrated. The LLM-based tool can be an LLM code generator 104 which focuses on improving the performance of the input serial code 102. Performance of the input serial code 102 can be defined as the time taken to execute the code and generate an output (e.g., latency of code execution).

LLM code generator 104 can leverage concepts from parallel processing and generate distributed code which decomposes input serial code 102 into parallel tasks. The parallel tasks that were originally in input serial code 102 can then be executed concurrently or at least partially concurrently on a cluster of computing devices. In other words, embodiments of the present invention have more of an effect on high-level algorithmic improvements than actual implementation of the code itself (e.g., low-level algorithmic improvements). This improves the functioning of a computer by separating tasks. In situations where the network is made up of different types of GPUs made for different purposes, the distributed code can be generated to consider this can allocate GPU to tasks accordingly.

LLM code generator 104 uses a parallel computation model for execution on multiple computing devices rather than serial code execution, which occurs on a single computing device. This is because a distributed cluster 110 that performs parallel code 106 can be tasked with performing the same portion of the functions of the code many times (instead of all the functions in the code) such as training a neural network. GPUs are optimized for performing the same task instead of a variety of tasks, and there are efficiencies in economies of scale over performing input serial code 102 with CPUs, making parallel computing with GPUs preferable to serial computing. In an embodiment of the present invention, to fully appreciate the distributed cluster, distributing the execution of these AI models on separate GPUs is preferred, though execution on a single GPU is possible.

LLM code generator 104 leverages generative artificial intelligence (GenAI) and LLMs to automatically generate distributed version of input serial code 102 according to a user query 101. User queries 101 and prompts 105 can be natural language inputs, images, videos, audio, or another types of input that the LLM is capable of processing. User query 101 is the desired goal in non-technical terms (though user query 101 can be in technical terms if preferred), while prompt 105 is machine generated input to an AI model to generate parallel code 106.

LLM code generator 104 includes an LLM which is trained to automatically transform input serial code 102 into parallel (distributed) code 106 which can be executed on distributed cluster 110. Input serial code 102 can be generated by any number of LLMs.

Input serial code 102 and parallel code 106 can be written in any number of computer languages including C/C++, Python, Java, JavaScript/TypeScript, C#, Go, Rust, Swift, Kotlin, Ruby, PHP, Perl, SQL, etc. Other languages are also contemplated.

To execute tasks on separate computing devices, the LLM code generator 104 uses special program semantics, which use function calls to “services” on the component. The program semantics indicate which section of the code can be executed on a given computing device, separate from the others. The component can be an execution engine 108. Execution engine 108 can receive and execute parallel code 106 on distributed cluster 110. Through function calls, independent tasks can be executed in parallel on distributed cluster 110. The function calls can be independent API calls. This allows for dynamic, flexible, and adaptable code execution systems. For example, computing devices can be called for certain tasks or functions and otherwise available for other functions. In other words, the computing devices can be pooled such that they can be called by different entities performing different tasks. These computing devices can be employed when there is code to execute and be on standby otherwise so that other entities can perform other functions with the same computing devices at a later time or concurrently. Alternatively, depending on other system factors different computing devices can be employed to perform the same task. To put this another way, e.g., if a computing device is preferred to execute a certain function but is allocated to another, unrelated task or function, a different computing device can be assigned to perform the given function, rather than waiting for the preferred computing device.

In one embodiment of the present invention the code can be generated and executed in Python programing language and use the asyncio library to execute code concurrently. Other methodologies and similar or equivalent libraries in other languages are also contemplated such as, e.g., Trio, Curio, Twisted, Tokio, etc.

LLMs for responses through prompts 105 to achieve the desired results. Prompt 105 can be engineered to form parallel code 106 that can be executed in parallel by forming specific signals in the code to perform selected functions or portions of the code concurrently. These signals can be functions from a module in the programming language that allows code to be executed concurrently. Other signals are also contemplated.

In embodiments of the present invention, user query 101 is intended to denote the input that derives input serial code 102 and prompts 105 are inputs to LLM code generator 104 that derive parallel code 106. Since LLMs are quite sensitive to prompt 105 (and user query 101), rather than manually writing prompt 105, a training phase in LLM code generator 104 automatically generates a system prompt 105. System prompt 105 will guide the LLM to generate syntactically correct and performant distributed code for the given input serial code 102 (while ensuring that parallel code 106 performs the same functions as input serial code 102). Syntactically correct can mean that the program syntax can be correct and the program can run. Performant can mean the code can take advantage of the parallelism in the distributed code and run faster than the serial version.

The tasks performed in input serial code 102 and parallel code 106 are illustrated as shapes in sequential order. In input serial code 102 the first function to be performed is a trapezoid 112, then a circle 114, then a triangle 116, then a hexagon 118, then a pentagon 120, and then a square 122. This linear process can be separated onto several different computing devices to make the code more efficient through parallel processing. Instead, trapezoid 112, circle 114, and hexagon 118 can be performed at the same time (in parallel) on different computing devices which can reduce the execution time of the code. Further, these computing devices can be configured to optimize each process on them through the selection of specific hardware or other means. Computing devices can be configured and optimized to serve specific API calls.

Trapezoid 112 can embody code such as, e.g., defining variables, etc. Circle 114 can perform other operations concurrently with trapezoid 112, such as, e.g., importing modules. Triangle 116 can then execute the function defined using the variables from trapezoid 112 and a module from circle 114. While trapezoid 112 and circle 114 are being performed, hexagon 118 can also be performed concurrently since there is no dependency on hexagon 118 from triangle 116. The output from triangle 116 and hexagon 118 can then be combined in pentagon 120. The output from pentagon 120 can then be displayed graphically or returned in square 122.

In an exemplary embodiment of the present invention, execution engine 108 can use four servers, server one 124, server two 126, server three 128, and server four 130. While only three actions act most can be performed at one in the code illustrated in FIG. 1, an additional server may be present to supervise the other servers, perform other tasks, provide redundancy, or otherwise be used. Server one 124 can perform the function described in trapezoid 112 while server two 126 can perform the function described in circle 114 and server three 128 can perform the function described in hexagon 118. In alternative embodiments of the present invention, the servers can be optimized for a given task or can perform the next task in the sequence.

To be clear, embodiments of the present invention can be integrated with low-level optimization of the code which make each of the functions represented by the shapes more efficient. Embodiments of the present invention change when and where the code is executed (e.g., concurrently on different machines), not but not the manner in which the code is executed, which can be improved by other techniques in conjunction to those mentioned herein.

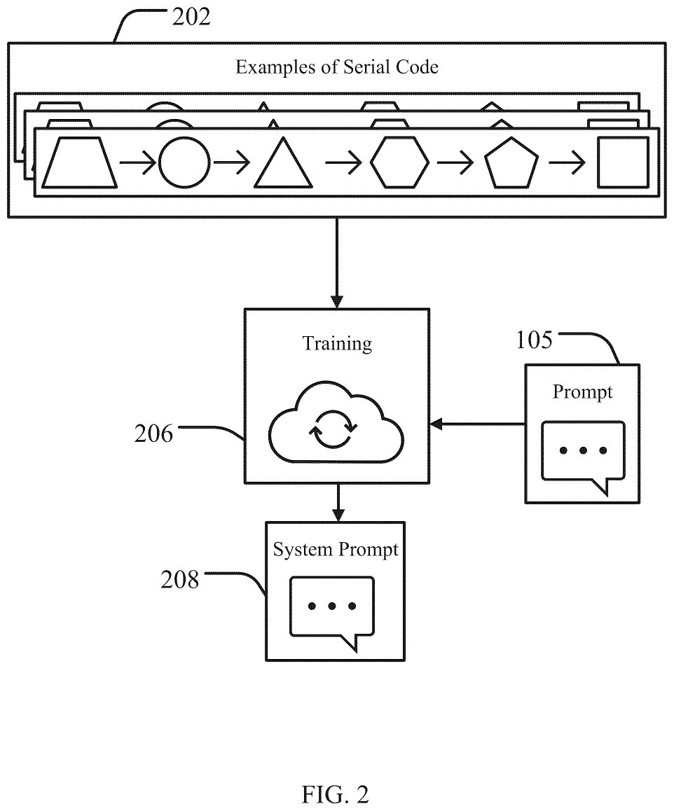

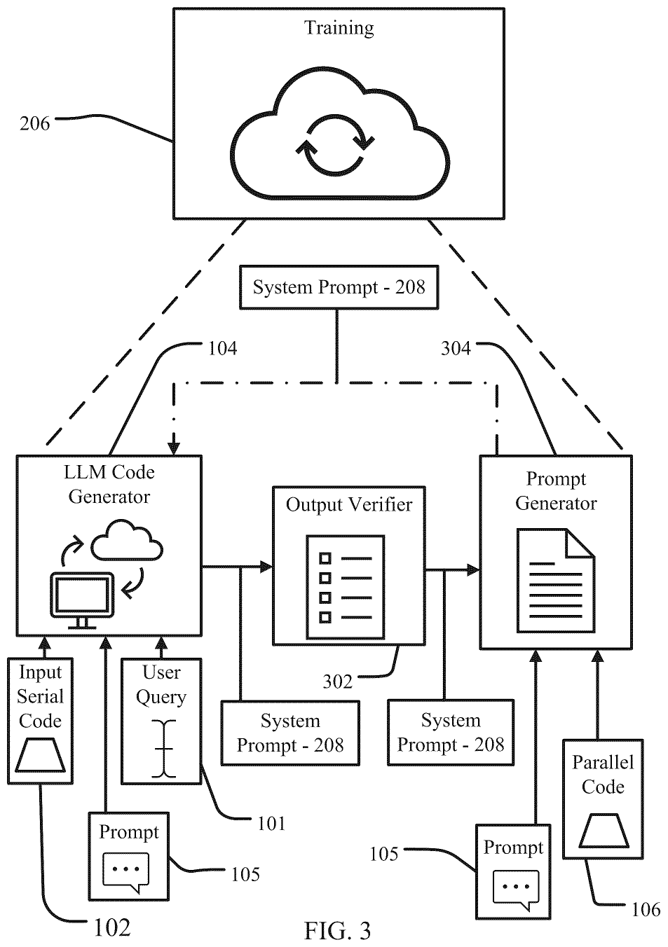

Referring to FIGS. 2 and 3, block diagrams of the training of LLM code generator 104 are illustrated in greater detail. The goal of the training phase is to derive a system prompt 208 which, given input serial code 102 and prompt 105, generates syntactically correct and performant parallel code 106 (FIG. 1), which can be executed on a distributed cluster 110 (FIG. 1). Input to the training phase 206 includes several example serial codes 202 along with corresponding prompt 105 for which there is a known ground truth output. The known ground truth is the generated output from the serial code which can be compared with the output from the generated distributed code.

Training phase 206 is started with a basic seed prompt (prompt 105) and iteratively revises prompt 105 automatically until syntactically correct and performant versions of the parallel code 106 (FIG. 1) are generated. Parallel code 106 (FIG. 1) can perform the same functions as the equivalent code in the several examples of serial code 202 and do so faster. Embodiments of the present invention maintain the accuracy and functionality of several examples of serial codes 202 while improving the code by reducing runtime (e.g., making the runtime faster). In other words, parallel code 106 has no functionality, operability, or other degradation in code quality (to a reasonable, predetermined degree, if at all).

To implement training phase 206, three different LLMs can be used. LLM code generator 104 generates distributed code for user query 101 and several example serial codes 202 based on prompt 105. During training phase 206, the prompt 105 for LLM code generator 104 continues to be revised. Revision occurs whenever prompt 105 cannot generate syntactically correct and performant parallel code 106 (FIG. 1).

Another LLM used is output verifier 302 which compares an output for a given system prompt 208 in several example serial codes 202 with an output for a given system prompt 208 in parallel code 106 (FIG. 1) and determines whether they match. If prompt 208 matches, then system prompt 105 for LLM code generator 104 stays constant, if not, another LLM is invoked to revise prompt 105.

A different LLM used during training phase 206 can include prompt generator 304 which refines prompt 105 for LLM code generator 104 whenever the generated distributed code does not pass the standards of output verifier 302. Input to prompt generator 304 can include prompt 105, incorrect parallel code 106, and output from the serial and distributed code execution (system prompt 208). With these inputs, prompt generator 304 analyses the reason prompt 105 was not able to generate a satisfactory version of parallel code 106 and then derives a new system prompt 208, which matches input serial code 102 better. Once training phase 206 is complete, LLM code generator 104 and prompt 105 are aligned to automatically generate parallel code 106.

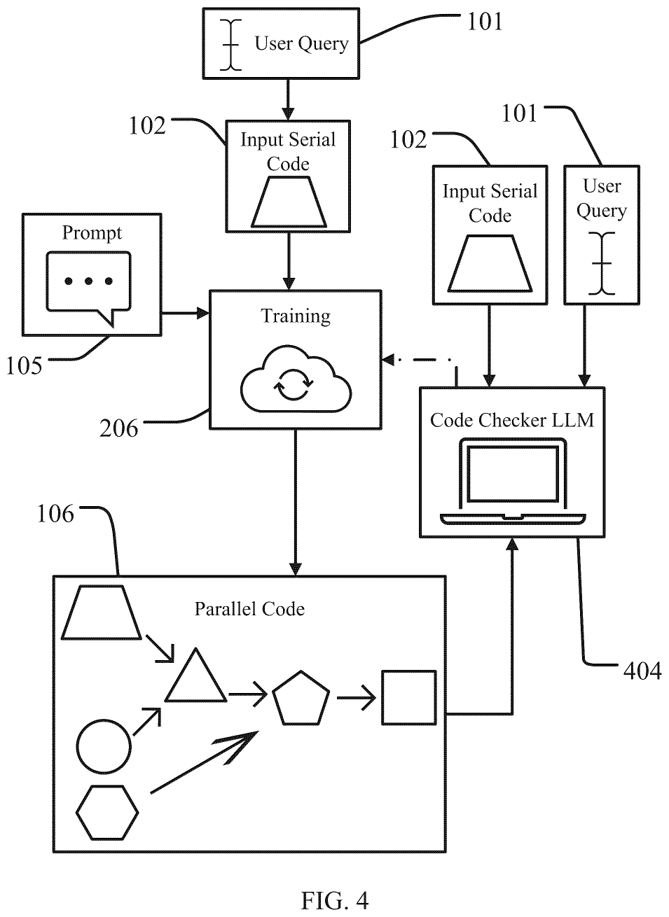

Referring to FIG. 4, a block diagram for inference generation of the LLM-based tool is illustrated. Once parallel code 106 is generated, the code is tested to determine whether the code is suitable for deployment or other use. To validate the performance of parallel code 106 another LLM is used. Code checker LLM 404 has as inputs user query 101, input serial code 102, and parallel code 106. With these inputs, code checker LLM 404 compares the two codes (parallel code 106 and input serial code 102) and determines whether parallel code 106 can generate the same output as input serial code 102. If the code passes, then the suggested parallel code 106 is given as the final output. If not, then another version of parallel code 106 is generated and compared. This continues until a suggested parallel code 106 version passes.

In further detail, several serial code 102 examples are executed to achieve output for verification purposes. For each input serial code 102, a corresponding parallel code 106 is also generated, with a corresponding output. Then, the two outputs are compared. If parallel code 106 is faster than the input serial code 102 (performant) and the outputs match, then the next input serial code 102 example is tested. If not, then a new prompt 105 is generated and applied to LLM code generator 104. The failed test is repeated until a configured maximum number of attempts to determine if the test is passed, e.g., generated parallel code 106 is performant and the output matches input serial code 102. Whenever a previously failed test passes, the process is repeated from the beginning to ensure that the refined system prompt 105 has not changed behavior for previously passed tests. This process continues until all tests pass for a minimum configured number of times. Once completed, the last system prompt 105 is used as the final instructions.

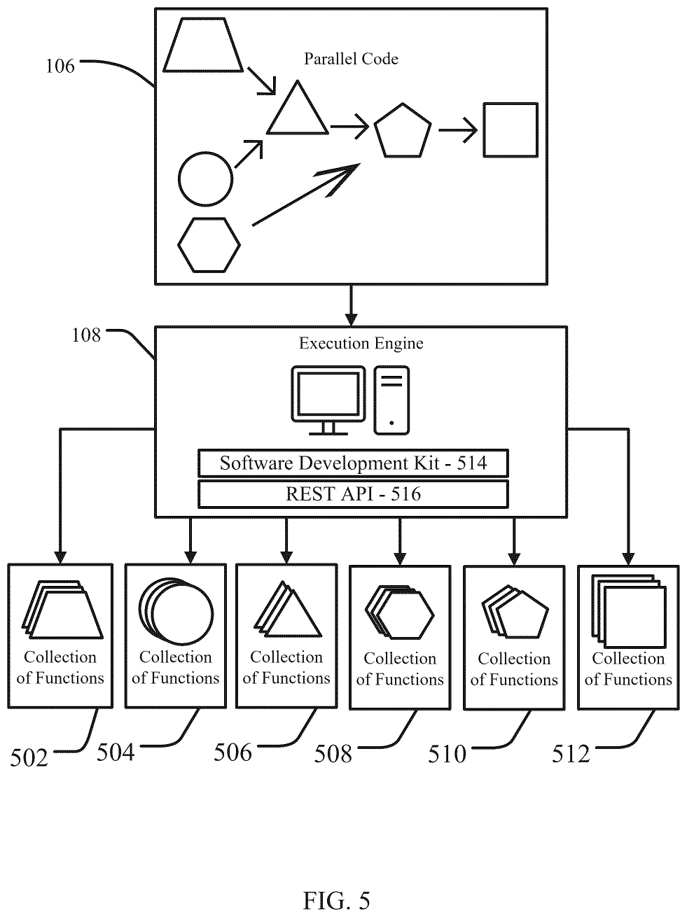

Now referring to FIG. 5, execution engine 108 is described in further detail. While LLM code generator 104 (FIG. 1) automatically generates a distributed version of input serial code 102 (FIG. 1) to improve code performance, execution engine 108 focuses on efficient execution of the generated parallel code 106 on a set of distributed computing devices, e.g., cluster of computer devices (distributed cluster 110). Input to execution engine 108 is the parallel code 106 generated by LLM code generator 104.

Since LLM code generator 104 is aware of the underlying runtime, parallel code 106 already incorporates special program semantics to invoke function calls to “services” on execution engine 108. These function calls are understood by execution engine 108 and executed efficiently on the underlying distributed infrastructure (e.g., distributed cluster 110). These function calls are indications in parallel code 106 that separate the code into different computing devices. In other words, the function calls are indicators in the code that reflect when parallel operations can be performed. In some embodiments of the present invention. programming language libraries can be imported into the code and have functions to indicate which functions can be performed concurrently.

In some embodiments of the present invention, execution engine 108 can be paired with third-party solutions, such as, e.g., Kubernetes, though third-party solutions are not necessary. The third-party solutions can be container orchestration frameworks that act as an “operator” to package, deploy, and manage Kubernetes applications. The operator exposes a new “kind” called “function,” through which various functions as a “service” can be deployed on the third-party solution. The “kind” is a Kubernetes installed to create clusters using docker container nodes. The “service” is a way to expose a set of pods as a network service. These functions are stateless and serverless since execution engine 108 manages the computing devices and is transparent to the source writing or invoking the functions.

Various functions can be deployed on execution engine 108, each performing a specific task (e.g., portion of parallel code 106 that is on a separate computing device). Each function forms a “deployment” and execution engine 108 creates multiple copies/instances of each function and executes them as “pods” within the third-party solution. There are several ways to invoke a function that runs on execution engine 108. For example, several copies of the function represented by trapezoid 112 can form collection of functions 502. A collection of functions 504 can be for circle 114, a collection of functions 506 can be for triangle 116, a collection of functions 508 can be for hexagon 118, a collection of functions 510 can be for pentagon 120, and a collection of functions 512 can be for square 122.

One approach to invoke the function includes applying a software development kit 514 (SDK). A purpose of SDKs 514 is to provide a collection of tools, libraries, documentation, code samples, processes, guides, etc., which can create applications integrated into specific third-party platforms, operating systems, frameworks, or programming languages. SDK 514 is generally developed by a third-party. Execution engine 108 exposes SDK 514 to implement different functions/services. In other words, SDK 514 has a “run” function, which takes in a callback function as an argument (parallel code 106). Execution engine 108 invokes this callback function whenever there is a request on a particular function/service as determined by LLM code generator 104.

Another way to invoke the function that runs on execution engine 108 includes a representational state transfer (REST) API 516 which also allows interfacing with the function/service. The execution engine 108 exposes functions and services via dedicated endpoints. Upon receiving a “POST” request with the proper parameters/inputs, the execution engine 108 processes POST request and returns a response.

To execute requests received on different functions/services (either through SDK 514 or REST API 516), execution engine 108 internally maintains a queue for each function/service. Whenever a request is received for any function, the request is put at the end of the queue corresponding to the function. Each queue is processed independently to serve function requests. Execution engine 108 maps each request to one of the available copies (“pods”) of the function and executes them on a first-come, first-serve basis. At the time of execution, if the request is no longer valid, e.g. if the sender no longer needs the response, then execution engine 108 automatically removes the request from the queue. By having separate queues and processing requests concurrently, execution engine 108 ensures efficient execution of parallel code 106 on the underlying cluster of computing devices. This is true not only processing requests between various functions, but also within a specific function.

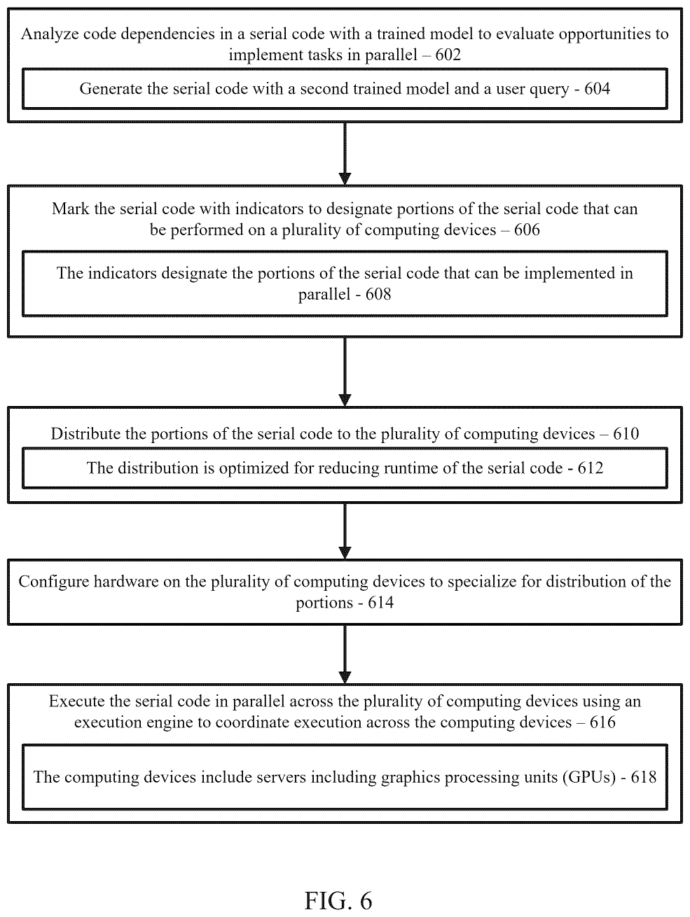

Referring to FIG. 6, a flow diagram demonstrating a method for generating and executing the distributed code is illustrated. The distributed code can be considered a parallel version of the serial code. In block 602, code dependencies are analyzed in serial code with a trained model to evaluate opportunities to implement tasks in parallel. The code dependencies can be direct or transitive. Additionally, the dependencies can be critical or convenient, etc. The serial code is evaluated to determine which functions are dependent on one another or otherwise need to be performed sequentially and which functions can be performed in parallel. This can be done by evaluating whether there is read after write dependencies (RAW), write after read dependencies (WAR), or write after write dependencies (WAW). Alternative embodiments of the present invention can also evaluate whether there is sufficient workload including considerations such as, e.g., thread/process creation, context switching, synchronization, data transfer, Amdahl's Law, and the type of parallelism (e.g., embarrassingly parallel, data parallelism, task parallelism, pipelining). Even further embodiments of the present invention can consider shared states and synchronization, and input/output operations.

In block 604, the serial code is generated with a second trained model and a user query. The user query can be highly technical and detailed, very basic with minimal technical jargon, or some combination. The serial code can be a program tasked to perform a task where the objective of embodiments of the present invention is to analyze, identify, and implement parallel version of the serial code. Embodiments of the present invention can be seeking to optimize for reduced runtime. Runtime can be defined as the time period when a program is actively executing. Reducing the runtime can reduce the time necessary for using GPUs and other computing devices.

The user prompt can be entered into the second trained model to form the serial code. The second trained model can be the same trained model which analyzes the serial code for dependencies.

In block 606, the serial code is marked with indicators to designate portions of the serial code that can be performed on a plurality of computing devices. The markers (e.g., markings, indicators, etc.) can be embedded in the code such as functions in the code, comments in the code, compiler and preprocessor markers, test markers, documentation markers, instrumentation markers, semantic and language markers. Other means of marking the code are also contemplated.

In block 608, the indicators designate the portions of the serial code that can be implemented in parallel. The markers can determine which portions of the code have dependencies and which do not have dependencies (e.g., that can be performed in parallel). The parallel version of the serial code can have semantic indicators to reflect areas that can be performed in parallel. The semantic indicators can be variable names, comments, functions (pre-defined or defined within the code), function names/parameters, type annotations and hints, constants and enumeration, system design patterns and architecture, error handling, file and folder structure, specific functions called and employed, etc.

In block 610, the portions of the serial code are distributed to the plurality of computing devices. In block 612, the distribution is optimized for reducing runtime of the serial code. This optimization can include assigning certain portions of the code to certain hardware, servers with certain memory capacity, servers closer to certain databases to reduce latency or response time, consider computing device computing power, etc. Other ways to optimize the distribution can be for throughput, error rate, resource utilization (e.g., CPU usage, memory usage, disk input and output, and network bandwidth), application availability, etc.

In block 614, the hardware on the plurality of computing devices is configured to specialize for the distribution of the portions of serial code. The computing devices can be paired with other computing hardware such as random access memory (RAM), read only memory (ROM), databases, preselected hardware, proximity to a computer processor unit (CPU) to reduce latency, etc.

In block 616, the serial code is executed in parallel across the plurality of computing devices using an execution engine to coordinate execution across the computing devices. The execution engine can assign portions of the code based on the hardware or other considerations such as hot code paths, etc. In block 618, the computing device can be a GPU. Other computing devices are also contemplated such as an NPU or TPU. The parallel version of the serial code can perform identically to the original serial code, or close enough that the output of the parallel version of the serial code is within a threshold of the original serial code. The parallel version of the serial code can be performed concurrently or at least partially concurrently on the plurality of computing devices at a time.

In some embodiments of the present invention, the parallel version of the serial code and the original serial code are compared to determine whether the distributed code is at least within a quality standard of the serial code. The quality standard can be performance, accuracy, speed, maintainability, readability, clarity, reusability, scalability/extensibility, adherence to industry practices and company practices, length, complexity, other key performance indicators, user satisfaction, and economic results directly or tangentially attributable to the code.

Some examples of accuracy can be adherence to client or internal requirements and project scope, ability to handle edge cases, known bugs or unexpected behaviors, robustness. Some examples of performance can be resource efficiency (CPU, memory usage, minimizing input and output operations). Some examples of maintainability can be consistent formatting, logical flow, comments, modularity, loose coupling, high cohesion, simplicity (e.g., adherence to Occam's Razor), testability, error handling, logging, etc. Some examples of adherence to best practices can be coding standards, design patterns, security, etc. These lists are not intended to be limiting and are non-exclusive.

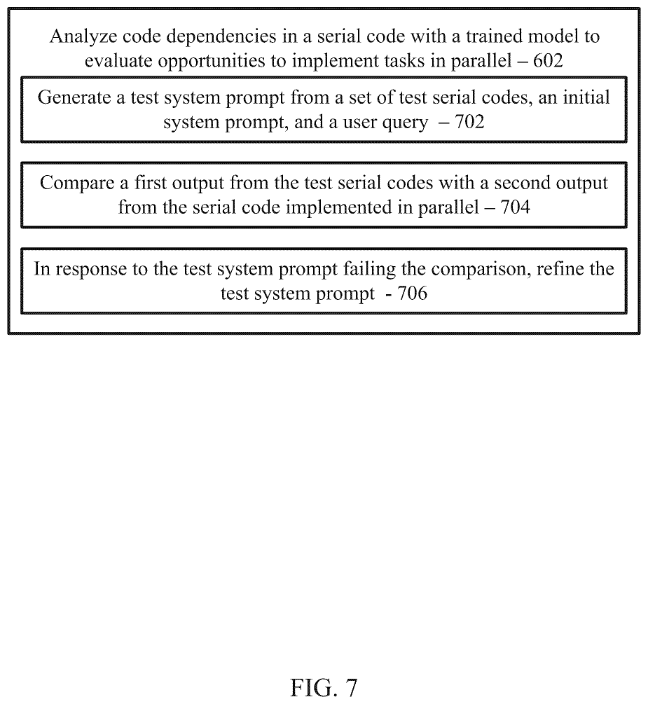

Referring to FIG. 7, a block diagram for forming the system prompt is illustrated, in accordance with an embodiment of the present invention. In block 702, a test (system) prompt is generated from a test serial code, an initial system prompt, and a user query. The test prompt can become the system prompt if the output from an LLM which is prompted from the test prompt is satisfactory. Satisfactory can mean the outputs are the same or close by predefined metrics.

In block 704, the output of the test serial code is compared with the output of parallel code generated in accordance with a test prompt. In block 706, if the test prompt were to fail the comparison, e.g., the output was not satisfactory, the test prompt is refined and tested again in response to the failure. In other words, the test prompt is adaptively refined based on output in response to the failure. For example, if the test prompt was too narrow (or broad), then the refinement can make the test prompt broader (or narrower). Alternatively, if the test prompt was ambiguous to multiple different applications or functions and did not provide the correct (intended) output, then the refinement can make the test prompt have constraints, guard rails, examples, or other information. In other embodiments of the present invention, retrieval augmentation generation (RAG) can be employed, and use other refinement techniques.

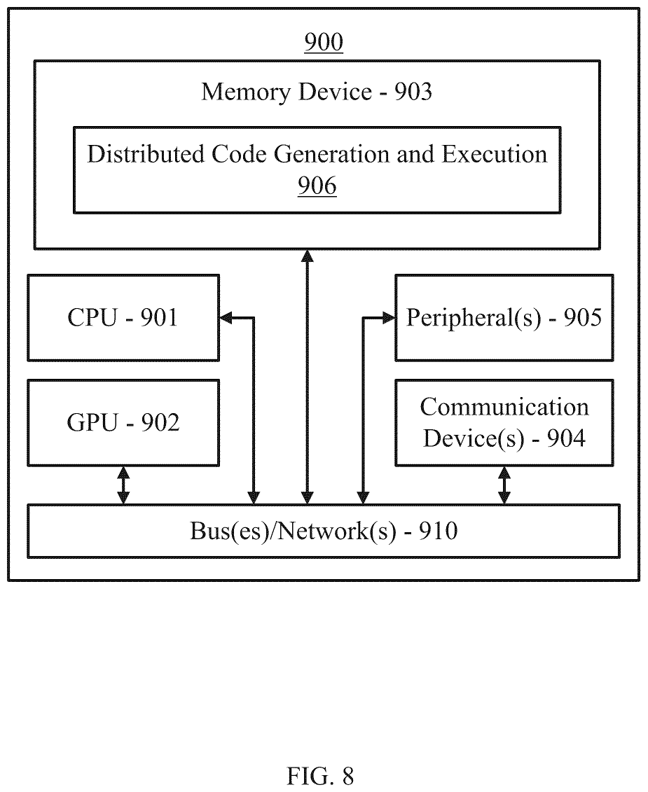

Referring to FIG. 8, a block diagram is shown for an exemplary processing system 900, in accordance with an embodiment of the present invention. The processing system 900 includes a set of processing units (e.g., CPUs) 901, a set of GPUs 902, a set of memory devices 903, a set of communication devices 904, and a set of peripherals 905. CPUs 901 can be single or multi-core CPUs. The GPUs 902 can be single or multi-core GPUs. The one or more memory devices 903 can include caches, RAMs, ROMs, and other memories (flash, optical, magnetic, etc.). The communication devices 904 can include wireless and/or wired communication devices (e.g., network (e.g., Wi-Fi®, etc.) adapters, etc.). The peripherals 905 can include a display device, a user input device, a printer, an imaging device, and so forth. Elements of processing system 900 are connected by one or more buses or networks (collectively denoted by the figure reference numeral 910).

In an embodiment of the present invention, memory devices 903 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 903 store program code or software 906 for distributed code generation and execution. The code generation and execution implement one or more functions of the systems and methods described herein for generating and executing serial code in parallel. The generation and execution software 906 further includes analyzing code dependencies in a serial code with a trained model to evaluate opportunities to implement tasks in parallel, marking the serial code with indicators to designate portions of the serial code that can be performed on a plurality of computing devices, distributing the portions of the serial code to the plurality of computing devices, and executing the serial code in parallel across the plurality of computing devices using an execution engine to coordinate execution across the computing devices. The memory devices 903 can store program code for implementing one or more functions of the systems and methods described herein.

Of course, the processing system 900 may also include other elements (not shown), as readily contemplated by one of skill in the art, as well as omitting certain elements. For example, various other input devices and/or output devices can be included in processing system 900, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 900 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 900.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

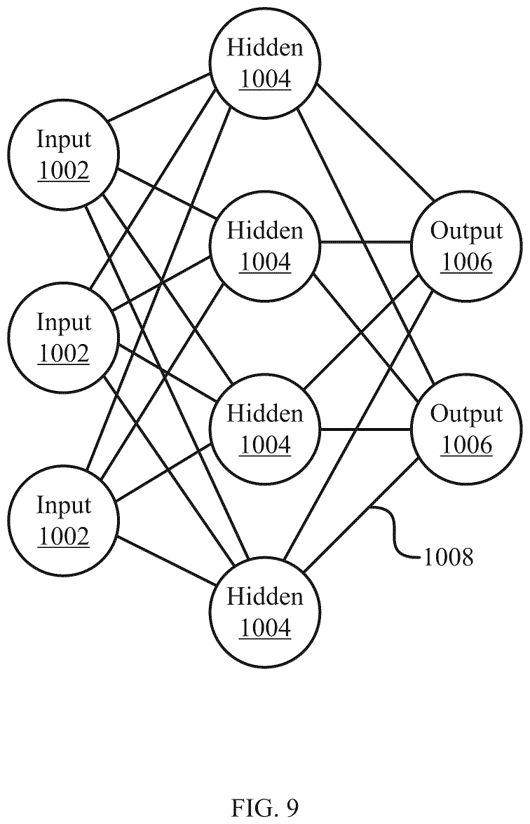

Referring to FIG. 9, a generalized diagram of a neural network is shown. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process. The ANN can identify patterns in text or other forms of communication and form embeddings for future processing. These patterns can relate actions and objects, relate objects to other objects, or actions to other actions. The ANN can identify seemingly unrelated or innocuous patterns or relationships with correlations. The ANN can bound objects into bounding boxes, extract objects from bounding boxes, classify actions, embed objects from features, and extract actions from text, among other capabilities.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 1002 that provide information to one or more “hidden” neurons 1004. Connections 1008 between the input neurons 1002 and hidden neurons 1004 are weighted, and these weighted inputs are then processed by the hidden neurons 1004 according to some function in the hidden neurons 1004. There can be any number of layers of hidden neurons 1004, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 1006 accepts and processes weighted input from the hidden neurons 1004.

This represents a “feed-forward” computation, where information propagates from input neurons 1002 to the output neurons 1006. Upon completion of a feed-forward computation, the output is compared to a desired output available from training data. The error relative to the training data is then processed in “backpropagation” computation, where the hidden neurons 1004 and input neurons 1002 receive information regarding the error propagating backward from the output neurons 1006. Once the backward error propagation has been completed, weight updates are performed, with the weighted connections 1008 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each connection 1008 weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

The ANN can be integrated into distributed code generation and execution by generating the code. LLMs are a type of ANN. LLM code generator 104 (FIG. 1), output verifier 302 (FIG. 3), and prompt generator 304 (FIG. 3). There can be several modules in the ANN that can perform the same, similar, or different tasks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for generating and executing serial code in parallel, comprising:
analyzing code dependencies in a serial code with a trained model to evaluate opportunities to implement tasks in parallel;
marking the serial code with indicators to designate portions of the serial code that can be performed on a plurality of computing devices;
distributing the portions of the serial code to the plurality of computing devices; and
executing the serial code in parallel across the plurality of computing devices using an execution engine to coordinate execution across the computing devices.

2. The method of claim 1, wherein the distribution is optimized for reducing runtime of the serial code.

3. The method of claim 1, further comprising:
generating the serial code with a second trained model and a user query.

4. The method of claim 1, wherein the trained model that analyzes the code dependencies further comprises:
generating a test system prompt from a set of test serial codes, an initial system prompt, and a user query;
comparing a first output from the test serial codes with a second output from the serial code implemented in parallel; and
in response to the test system prompt failing the comparison, refining the test system prompt.

5. The method of claim 1, wherein the indicators designate the portions of the serial code that can be implemented in parallel.

6. The method of claim 1, further comprising:
configuring hardware on the plurality of computing devices to specialize for distribution of the portions.

7. The method of claim 1, wherein the plurality of computing devices include graphics processing units (GPUs).

8. A system for generating and executing serial code in parallel, comprising:
a processor; and
a memory storing computer-readable instructions that, when executed by the processor, cause the system to:
analyze code dependencies in a serial code with a trained model to evaluate opportunities to implement tasks in parallel;
mark the serial code with indicators to designate portions of the serial code that can be performed on a plurality of computing devices;
distribute the portions of the serial code to the plurality of computing devices; and
execute the serial code in parallel across the plurality of computing devices using an execution engine to coordinate execution across the computing devices.

9. The system of claim 8, wherein the distribution is optimized for reducing runtime of the serial code.

10. The system of claim 8, wherein the memory further causes the system to:
generate the serial code with a second trained model and a user query.

11. The system of claim 8, wherein the trained model that analyzes the code dependencies further causes the system to:
generate a test system prompt from a set of test serial codes, an initial system prompt, and a user query;
compare a first output from the test serial codes with a second output from the serial code implemented in parallel; and
in response to the test system prompt failing the comparison, refine the test system prompt.

12. The system of claim 8, wherein the indicators designate the portions of the serial code that can be implemented in parallel.

13. The system of claim 8, wherein the memory further causes the system to:
configure hardware on the plurality of computing devices to specialize for distribution of the portions.

14. The system of claim 8, wherein the plurality of computing devices include graphics processing units (GPUs).

15. A computer program product comprising a non-transitory computer-readable storage medium containing computer program code, the computer program code when executed by one or more processors causes the one or more processors to perform operations, the computer program code comprising instructions to:
analyze code dependencies in a serial code with a trained model to evaluate opportunities to implement tasks in parallel;
mark the serial code with indicators to designate portions of the serial code that can be performed on a plurality of computing devices;
distribute the portions of the serial code to the plurality of computing devices; and
execute the serial code in parallel across the plurality of computing devices using an execution engine to coordinate execution across the computing devices.

16. The computer program product of claim 15, wherein the distribution is optimized for reducing runtime of the serial code.

17. The computer program product of claim 15, wherein the computer program code instructions further comprise:
generate the serial code with a second trained model and a user query.

18. The computer program product of claim 15, wherein the computer program code instruction further comprise:
generate a test system prompt from a set of test serial codes, an initial system prompt, and a user query;
compare a first output from the test serial codes with a second output from the serial code implemented in parallel; and
in response to the test system prompt failing the comparison, refine the test system prompt.

19. The computer program product of claim 18, wherein the indicators designate the portions of the serial code that can be implemented in parallel.

20. The computer program product of claim 18, configure hardware on the plurality of computing devices to specialize for distribution of the portions.
